(19) United States
(12) Patent Application Publication
(10) Pub. No.: US 2015/0041015 A1
(43) Pub. Date: Feb. 12, 2015

(54) Block-Off Plate Assembly for Carburetor Float Bowl

(71) Applicants: Thomas E. Wilson, JR., LaGrange, GA (US); Carol Walston, LaGrange, GA (US)

(72) Inventors: Thomas E. Wilson, JR., LaGrange, GA (US); Carol Walston, LaGrange, GA (US)

(21) Appl. No.: 13/961,175

(22) Filed: Aug. 7, 2013

(51) Int. Cl. F02M 19/00; F16L 55/11

(52) U.S. Cl. CPC F02M 19/00; F16L 55/1108
USPC 138/89

(57) ABSTRACT

A block-off plate assembly for preventing gasoline leakage near the outer surface of a carburetor bowl of the type used on motorbikes and all-terrain vehicles, comprising two components, the first being a custom-machined plate fabricated from a suitable rigid material. The plate further comprises a smooth, inner planar surface, a parallel, planar outer surface, and a circular channel, machined to a specific depth, into the inner surface. Left and right apertures, both equally sized, are through-drilled into the left shoulder and right shoulder, respectively, of the block-off plate to accommodate the insertion of a machine screw through each aperture. The second component comprises an elastomeric O-ring having dimensions corresponding to the circular channel, thereby serving to provide effective fluid-tight sealing of an orifice in the carburetor bowl.

### REFERENCE TO RELATED APPLICATION

Not Applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept presented herein generally is concerned with devices and methods of preventing fluid leakage, particularly gasoline, between close-fitting components of a carburetor of a motorbike, all-terrain vehicle, or similar motorized equipment.

(2) Description of the Related Art

The following references have some related similarities, either in function, or construction to the inventive concept:

U.S. Pat. No. 8,136,819 B2 (Mar. 20, 2012) There is provided a sealing structure and a gasket which can seal both of a portion where a groove for mounting the gasket is formed and a portion where a groove for mounting the gasket is not formed when the portions are connected.

U.S. Pat. No. 7,926,818 B2 (Apr. 19, 2011) A gasket to securely contact a box type body when both a body and a cover are downsized and thinned. Fluid leakage is prevented through a seal by lessening repulsion of the seal at the time of sealing clearance between. A clearance between the box type body and the cover is made such that a main body is adhered to a bottom surface of the cover having a peripheral wall.

U.S. Pat. No. 7,398,962 B2 (Jul. 15, 2008) A device for enhancing quick replacement of the fuel metering jets of an internal combustion engine carburetor. Fuel float bowls permit the jets to face upward. The jets are removed through access holes in the upper wall of the float bowl by a screwdriver/gripping tool.

U.S. Pat. No. 7,241,099 B2 (Jul. 10, 2007) A self-retaining O-ring having at least two radial struts connectively extending from inside surfaces to a central sphere-shaped retainer. The top surfaces of the radial struts are formed below the top surfaces of the O-ring. A circular recess is provided for containing and supporting the O-ring

U.S. Pat. No. 6,824,140 B2(Nov. 30, 2004) A manway cover gasket wherein the manway cover has a groove into which a gasket is adapted to be mounted. The gasket has an annular metal insert having a top surface and bottom surface, and an inside edge and an outside edge and corresponding inside and outside diameters. The metal insert and the manway cover groove are correspondingly sized.

### BRIEF SUMMARY OF THE INVENTIVE CONCEPT

The inventive concept herein involves a rhomboidal-shaped, rigid block-off plate assembly having an integral circular channel for retention of a corresponding, custom-fitted O-ring. The inventive concept is utilized under circumstances where it is necessary to seal an orifice existing on the surface of a metallic member of a carburetor bowl. In situations of this nature, it is common to use some type of elastomeric gasket or sealing member between two interfacing relatively flat surfaces. For effective functioning of the inventive concept disclosed, an O-ring may be mounted in a circular channel in order to effectively prevent the leakage of fluid in the junction of two engine components. In particular, the inventive concept disclosed is used to prevent fuel leakage from an orifice of a carburetor bowl, where the orifice had been previously sealed by insertion of an original equipment fuel primer mechanism.

The block-off plate disclosed comprises two components. The first component is a custom-dimensioned plate fabricated from a suitable rigid material. The plate comprises a smooth, planar inner surface and a parallel, planar outer surface. The inner surface further features a circular channel, symmetrically machined to a specific depth, into the inner surface. The plate further comprises a left and a right aperture, both apertures equally sized to accommodate the insertion of a machine screw through each respective aperture. The second component of the device is an elastomeric O-ring having dimensions corresponding to the inner and outer circumferences and the depth of the circular channel.

The device serves the function of providing a fluid-tight seal between the inner surface of the plate and an external surface of a carburetor float bowl of the type commonly found on many makes of all-terrain vehicles (ATV) and motor bikes, including Honda, Kawasaki, Suzuki, and the like. Two oppositely-positioned holes near the outer perimeter of the plate allow the insertion of two corresponding machine screws to attach the plate to the surface of the carburetor bowl. The end result is the prevention of fuel leakage from the carburetor bowl orifice previously closed off with a fuel primer mechanism. The preferred embodiment of the device is calibrated and designed to function on Honda 4-cylinder motorcycle engines.

### BRIEF DESCRIPTION OF THE VIEWS OF THE DRAWINGS

The objects, features, and advantages of the concept presented in this application are more readily understood when referring to the accompanying drawings. The drawings, totaling seven figures, show the basic functions of various embodiments and methods. In the several figures, like reference numbers are used in each figure to correspond to the same component as may be depicted in other figures.

FIG. 1 shows a view of the inner surface of the block-off plate, including the circular channel and the left and right apertures.

FIG. 2 is a side view of the block-off plate, showing the placement and relative depth of the circular channel.

FIG. 2A is a typical machine bolt used for insertion through apertures 11, 12.

FIG. 3 displays the O-ring which tits within the circular channel of the block-off plate.

FIG. 4 is a perspective view of the typical carburetor found in many makes of motorbikes and all-terrain vehicles (ATV), with the primer control knob in place.

FIG. 5 is an isolated view of the carburetor bowl and primer control knob.

FIG. 6 illustrates the block-off plate having been attached to the carburetor bowl directly over the orifice previously sealed by the primer control mechanism.

FIG. 7 depicts the inner surface of the block-off plate, including literal symbols representing the dimensions required for proper function of the device.

FIG. 8 shows a side view with corresponding dimensions of the block-off plate in inches.

TABLE 1
Nomenclature for Block-Off Plate

| | |
|---|---|
| 1. | Block-off plate |
| 2. | Outer surface |
| 3. | Inner surface |
| 4. | O-ring |
| 5. | Circular channel |
| 6. | Channel inner circumference |
| 7. | Channel outer circumference |
| 8. | Channel depth |
| 9. | Left shoulder |
| 10. | Right shoulder |
| 11. | Left aperture |
| 12. | Right aperture |
| 13. | Upper contour |
| 14. | Lower contour |
| 15. | Plate side |
| 16. | Left machine screw |
| 17. | Right machine screw |
| 18. | Left threaded opening |
| 19. | Right threaded opening |
| 20. | Plate thickness |
| 21. | Upper left side |
| 22. | Upper right side |
| 23. | Lower right side |
| 24. | Lower left side |
| 25. | Primer knob |
| 26. | Robber boot |
| 27. | Original base |
| 28. | Interfacing surface |
| 29. | Carburetor bowl |
| 30. | Primer orifice |
| 31. | Left aperture center |
| 32. | Right aperture center |
| 33. | Channel center |

### DETAILED DESCRIPTION

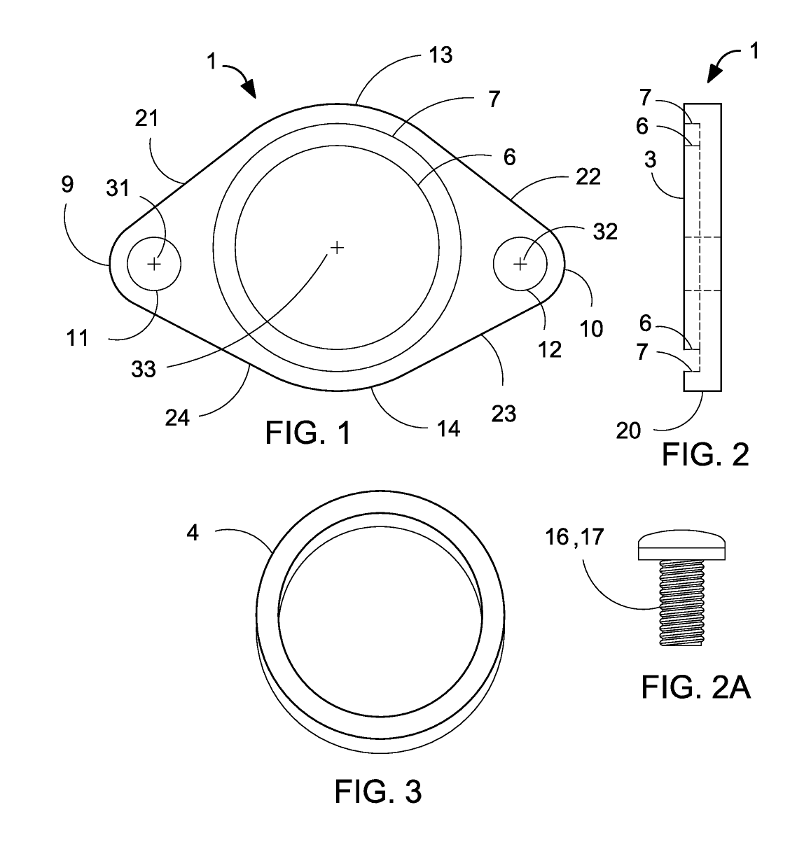

The description of the inventive concept is best understood by reference to the accompanying drawing figures, totaling eight in number. In FIG. 1 there is presented a head-on view of the inner surface 3 of the block-off plate 1. The general profile of the block-off plate 1 is a rhomboid shape. Looking at the inner surface 3 of the block-off plate 1, it can be described, in a clockwise manner, as having an upper contour 13, an upper right side 22, a right shoulder 10, as lower right side 23, a lower contour 14, a lower left side 24, a left shoulder 9, and an upper left side 21.

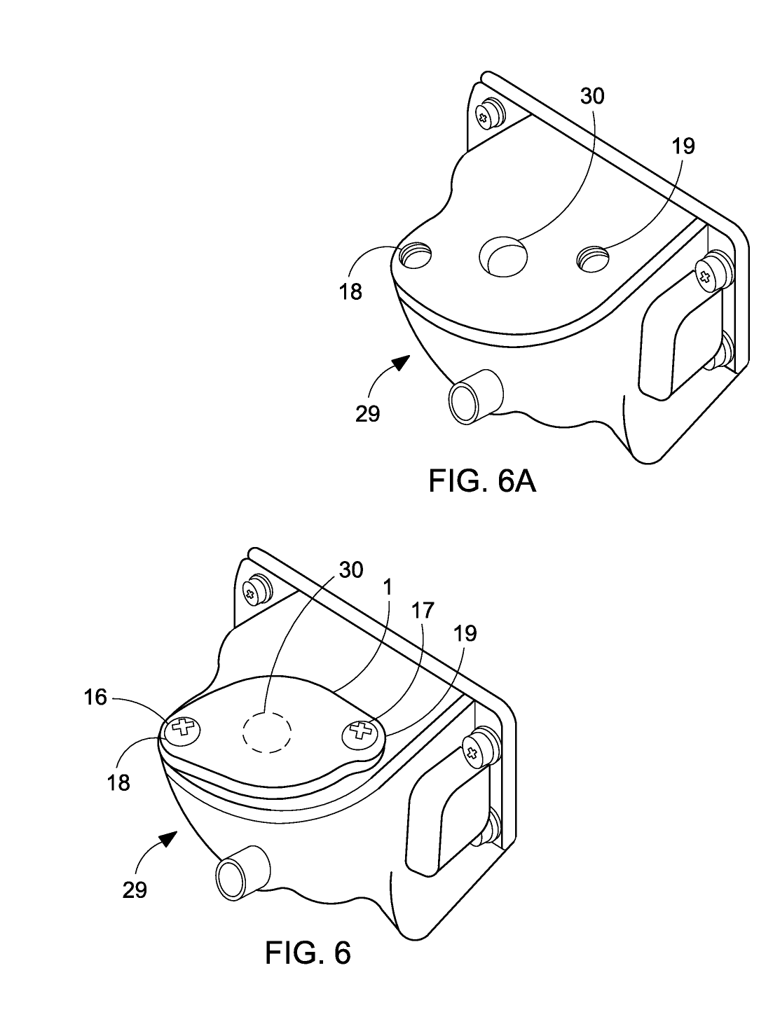

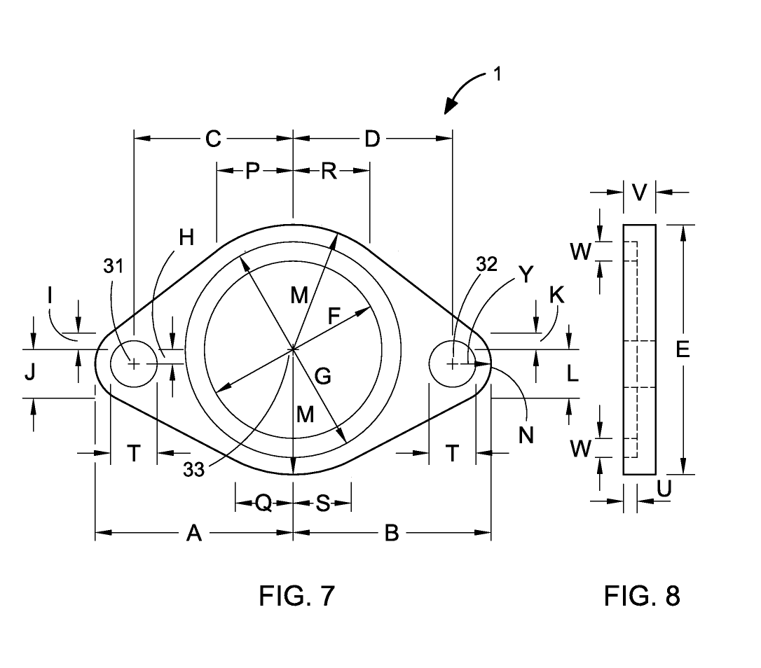

The profile features defined in this document provide a precise fit of the block-off plate 1 flush onto the surface of a carburetor bowl 29, as shown in FIG. 6A. The ultimate leak-proof fitting of the block-off plate 1 over a particular orifice 30, of a carburetor bowl 29 found on many makes of motorbikes and all-terrain vehicles is depicted in FIG. 6A. A detailed presentation of the dimensions required for the block-off plate 1 to function adequately is shown in FIG. 7 and FIG. 8.

Returning to FIG. 1, there is shown a left aperture 11 and a right aperture 12, the apertures having been drilled through the left shoulder 9 and the right shoulder 10, respectively of the block-off plate 1. Both apertures 11, 12 are dimensioned so as to allow insertion of corresponding machine screws 16, 17, through each of the respective apertures 11, 12. The machine screws 16, 17, are original equipment screws used for fastening the original equipment plate component, by means of correspondingly threaded openings 18, 19 found on the carburetor bowl 29, as shown in FIG. 6.

Due to the particular location of the orifice 30 of the carburetor bowl 29 proximate other parts of the carburetor, the block-off plate 1 must be dimensioned and machined precisely. Consequently, the block-off plate 1 is not exactly symmetrical from a top-to-bottom perspective. FIG. 7 demonstrates the asymmetric relationship of the overall profile of the block-off plate 1. Table 2 presents literal representations of the various dimensions of the block-off plate 1.

Referring to FIG. 1, there is illustrated a head-on view of the circular channel 5, which is machined to a certain depth into the inner surface 3 of the block-off plate 1. The inner circumference 6 and the outer circumference 7 of the circular channel 5 are indicated. A left side view of the circular channel 5 is shown in FIG. 2. An O-ring 4, which corresponds exactly to the dimensions of the circular channel 5, is shown in FIG. 3. The sealing component, being a conventional O-ring 4, provides a fluid-tight seal when inserted between the walls 6, 7 of the circular channel 5.

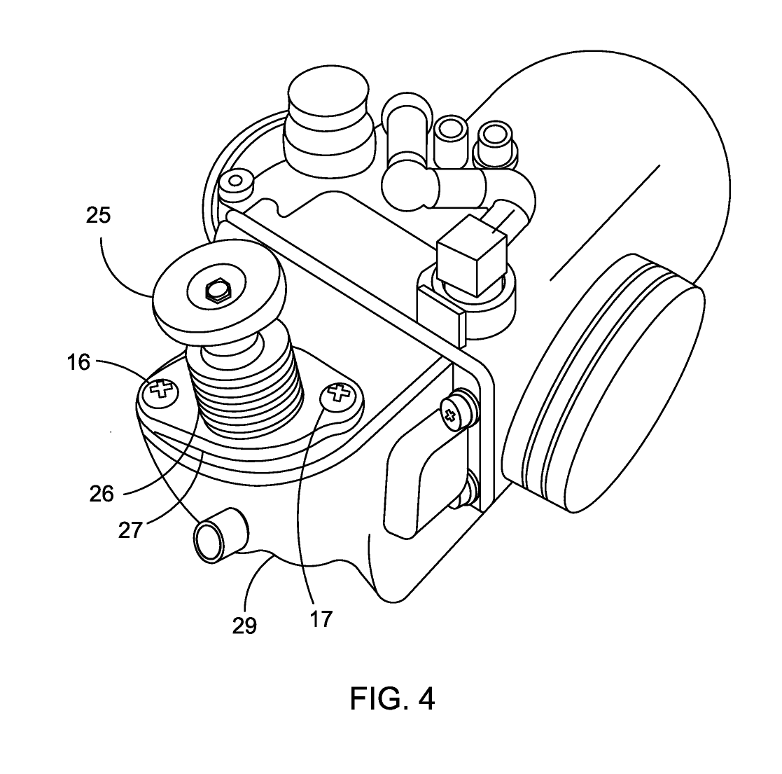

FIG. 4 depicts a carburetor assembly for a motorcycle or all-terrain vehicle engine, and particularly, the carburetor bowl 29. A fuel primer comprising essentially a primer knob 25 and a rubber boot 26 housing a spring (not shown) are pictured fastened to the carburetor bowl 29 by means of an original equipment plate 27 and two machine screws 16, 17.

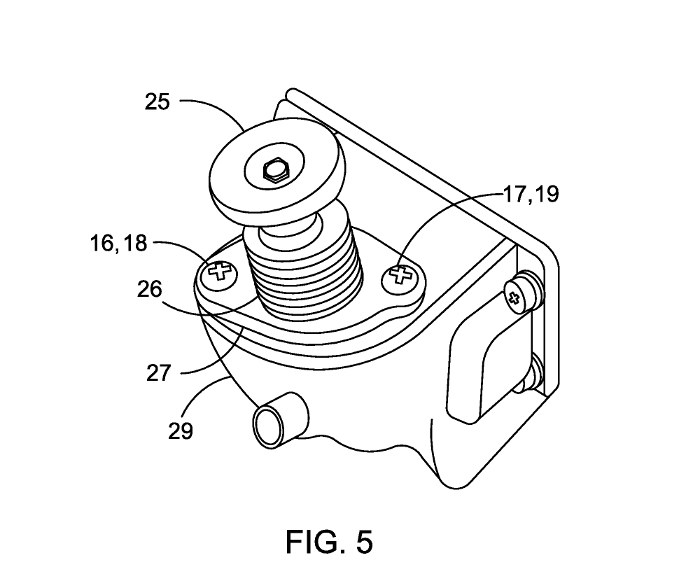

FIG. 5 depicts a stand-alone view of the carburetor bowl 29 before removal of the essential parts of the fuel primer, being the primer knob 25, rubber boot 26, machine screws 16, 17, and the original plate 27. The original fuel primer equipment must be removed and replaced due to wear and tear of the equipment over time. FIG. 6 displays the carburetor bowl, absent the original equipment fuel primer, and exposing an orifice 30 which would normally be occupied by the fuel primer mechanism. Also shown in FIG. 6 are the left and right threaded openings 18, 19 which provide compatible threads to the machine screws 16, 17 and the flat attaching surface 28 of the carburetor bowl 29.

After removal of the original fuel primer assembly, the block-off plate 1 is secured over the orifice 30, as illustrated in FIG. 6A. The inner surface 3 (out of view) of the block-off plate 1 has been firmly placed against the fiat carburetor bowl surface 28, and the block-off plate 1 is then tightened by the two machine screws, 16, 17. The O-ring 4, being recessed into the circular channel 5 of the block-off plate 1, thereby provides a secure and leak-proof seal, preventing gasoline leakage from the confines of the carburetor bowl 29 past the orifice 30. The machine screws 16, 17 are recycled from the original equipment plate 27 of which the block-off plate 1 replaces.

To illustrate the precise dimensions of the block-off plate 1 which enable it to perform its leak seal function. FIG. 7 and FIG. 8 present a symbolized dimensional layout as applicable to construction of the block-off plate 1. The following Table 2 describes and defines, by literal symbols, the dimensional layout necessary for construction of the block-off plate 1:

TABLE 2
Listing of Block-Off Plate Dimensions (in inches)

A. Channel center to left shoulder = 0.642 inch;
B. Channel center to right shoulder = 0.721 inch;
C. Channel center to left aperture center = 0.505;
D. Channel center to right aperture center = 0.505;
E. Upper contour edge to lower contour edge = 0.914;
F. Inner diameter of Channel = 0.642;
G. Outer diameter of channel = 0.787;
H. Vertical offset of aperture extended horizontal centerlines
to channel extended horizontal centerline = 0.052;
I. Vertical distance from channel horizontally extended
centerline to beginning of upper left side = 0.059;
J. Vertical distance from channel horizontally extended
centerline to beginning of lower left side = 0.177;
K. Vertical distance from channel horizontally extended
centerline to beginning of upper right side = 0.049;
L. Vertical distance from channel horizontally extended
centerline to beginning of lower right side = 0.171;
M. Radius of upper and lower contours, respectively = 0.456;
N. Radius of left and right shoulders, respectively = 0.141;
P. Horizontal distance from channel vertically extended
centerline to beginning of upper left side = 0.318;
Q. Horizontal distance from channel vertically extended
centerline to beginning of lower left side = 0.245;
R. Horizontal distance from channel vertically extended
centerline to beginning of upper right side = 0.279;
S. Horizontal distance from channel vertically extended
centerline to beginning of lower right side = 0.211;
T. Diameter of left aperture and right aperture,
respectively = 0.170;
U. Depth of circular channel = 0.05;
V. Thickness of plate = 0.240;
W. Thickness of O-ring, and corresponding width of
channel = 0.0725;
X. Offset between horizontal extensions of channel
centerline and co-located apertures centerlines = 0.062;
Y. Radius of left and right shoulders,
respectively = 0.141;

In the preferred embodiment, the material used for the block-off plate is one-quarter inch 6061 aluminum. However, other metals or rigid materials may also be suitable for the block-off plate 1.

While certain embodiments of the present inventive concept have been shown and disclosed herein, it will be obvious to those persons skilled in the art that such embodiments are presented by way of example only and not as a limitation to the scope of the inventive concept. Variations, changes, and substitutions may occur or be suggested to those skilled in the art without departing from the intent, scope, and totality of this inventive concept. Accordingly, it is intended that this inventive concept not be limited by the scope of the accompanying claims, but by the entirety of the disclosure presented.

What is claimed is:

1. A contoured plate assembly for precise, leak-proof fit over an orifice normally occupied by a primer control mechanism secured in place by an original equipment plate having two machine screws fastened into two threaded openings in a carburetor bowl of the type being a component of the engine of a motorcycle or all-terrain vehicle (ATV), said plate assembly comprising:
(a) an essentially planar, rigid plate, said plate comprising a flat outer surface, an inner surface having a circular channel machined onto said inner surface, four linear sides sequentially connected by four arcuate corners, and said plate having two apertures oriented orthogonally to said inner and outer surface, said apertures located at opposite corners of said plate; and
(b) a circular, elastomeric O-ring comprising an inner diameter, thickness, and outer diameter of dimensions corresponding to said circular channel; wherein
said O-ring, when placed within said circular channel and said inner surface of the plate is centeredly placed over said orifice, flush with said carburetor bowl such that the two apertures are in correspondence with the two threaded carburetor bowl openings and two machine screws are thereupon individually inserted and rotated so as to secure the inner surface of said plate assembly and said O-ring, there is provided a secure, leak-proof fit against said carburetor bowl.

2. A contoured plate assembly for precise, leak-proof fit over an orifice normally occupied by a primer control mechanism secured in place by an original equipment plate having two machine screws fastened into two threaded openings in a carburetor bowl of the type integral to the engine of a motorcycle or all-terrain vehicle (ATV), said plate assembly comprising:
(a) an essentially planar, rigid plate, having a rhombus profile, said plate comprising
a flat outer surface,
an essentially flat inner surface, parallel, to said outer surface, and further laving the same rhombic profile as said outer surface,
four linear sides sequentially connected by four arcuate corners, said sides and corners alternatingly existing, in a clockwise manner, to form an upper contour, an upper right side, a right shoulder, a lower right side, a lower contour, a lower left side, a left shoulder, and an upper left side;
two circular apertures, one located at said left shoulder and one located at said right shoulder of said plate, both apertures oriented orthogonally to the respective inner and outer surfaces, and having co-located extended horizontal centerlines;
a circular channel machined to a certain depth into the inner surface, said circular channel having a center midway between said upper contour and said lower contour; and
(b) a circular, elastomeric O-ring comprising an inner diameter, thickness, and outer diameter of dimensions corresponding to said circular channel.

3. A contoured plate assembly for precise, leak-proof fit over an orifice normally occupied by a primer control mechanism secured in place by an original equipment plate haying two machine screws fastened into two threaded openings in a carburetor bowl of the type being a component of the engine of a motorcycle or all-terrain vehicle (ATV), said plate assembly comprising:
(a) an essentially planar, rigid plate, having a rhombus profile, said plate comprising
a flat outer surface,
an essentially flat inner surface, parallel to said outer surface, and further having the same rhombic profile as said outer surface,
four linear sides sequentially connected by arcuate upper and lower contours and arcuate left and right shoulders, said sides, contours, and shoulders alternatingly forming, in a clockwise manner while looking head-on at the inner surface, a left shoulder, an upper left side, an upper contour, an upper right side, a right shoulder, a lower right side, a lower contour, and a lower left side, said approximate dimensions of the plate being:
thickness from outer surface to inner surface, 0.235 inch;
horizontal length from center of circular channel to left shoulder, 0.642 inch;
horizontal length from center of circular channel to right shoulder, 0.721 inch;
left and right shoulders radius measured from aperture centers, 0.141 inch;
upper contour radius, measured from center of circular channel, 0.456 inch;
lower contour radius, measured from center of circular channel, 0.456 inch;
horizontal length, center of circular channel to left aperture extended vertical centerline, 0.505 inch
horizontal length, center of circular channel to right aperture extended vertical centerline 0.505 inch;
left and right circular apertures, one located at the left shoulder and one located at the right shoulder of said plate, both apertures oriented orthogonally to the respective inner and outer surfaces, and having co-located extended horizontal centerlines, each respective aperture having a diameter of 0.170 inch;
offset distance from circular channel extended horizontal centerline to co-located horizontal centerlines of apertures, 0.062 inch;
(b) a circular channel machined into the inner surface and having an outer diameter of 0.787 inch, inner diameter 0.642 inch, and a depth of 0.050 inch: and
(c) a circular, elastomeric O-ring comprising an outer diameter, inner diameter, and thickness of dimensions corresponding to the dimensions of said circular channel.
